(19) United States
(12) Patent Application Publication
(10) Pub. No.: US 2016/0204490 A1
(43) Pub. Date: Jul. 14, 2016

(54) BATTERIES

(71) Applicant: UNIVERSITY OF NEWCASTLE UPON TYNE, Newcastle upon Tyne, Tyne and Wear (GB)

(72) Inventor: Keith SCOTT, Tyne and Wear (GB)

(21) Appl. No.: 14/912,941

(22) PCT Filed: Aug. 20, 2014
(86) PCT No.: PCT/GB2014/052547

§ 371 Date: Feb. 19, 2016

(30) Foreign Application Priority Data
Aug. 21, 2013 (GB) 1314934.9

(51) Int. Cl. H01M 12/08; H01M 4/90; H01M 4/86

(52) U.S. Cl. CPC H01M 12/08; H01M 4/8668; H01M 4/8673; H01M 4/9016; H01M 4/9075; H01M 2004/8689

(57) ABSTRACT

This invention relates to metal-air batteries and methods of making metal-air batteries. The batteries may include a cathode which comprises an electronically conductive support; a solid metal carbonate; and a binding agent. The batteries may comprise a solvent reservoir in communication with the battery cell and arranged to trap gases emitted by the battery.

This invention relates to metal-air batteries and methods of making metal-air batteries. More specifically, the batteries to which this invention relates are metal-(O₂/CO₂) batteries. The invention also relates to cathodes and methods of making said cathodes.

### BACKGROUND

Significant efforts are required to find ways to minimise the use of fossil fuels in order to resolve environmental and energy supply concerns in the long-term. One sustainable option is to shift to clean and renewable energy resources such as solar, wind and geothermal power generation. One of the keys to success in using these technologies lies in developing reliable large scale high power energy storage devices.

The potentially very high energy density of the Li-air battery has spurred considerable recent interest in developing it for applications such as unmanned aerial vehicles and portable power sources.

In the mid-1990s, Abraham and co-workers demonstrated the first non-aqueous Li-air battery with the use of a Li negative electrode (anode), a porous carbon positive electrode (cathode), and a gel polymer, Li ion conducting, electrolyte membrane (Abraham, K. M., Jiang, Z, J. Electrochem. Soc. 143, 1, 1996). On discharge, O₂ from air enters the porous cathode and is reduced to O₂²⁻ where it combines with Li ions to form solid lithium oxides in the pores. Charging reverses this process.

The energy storage capacity and power capability of Li-air batteries are strongly determined by the nature of the air electrodes which contribute to most of the voltage drop of Li-air batteries. Currently, air electrodes in most Li-air batteries consist of porous carbon materials. In Li-air batteries, all of the Li—O₂ reactions occur on the carbon substrate, therefore it is critical to first build an ideal host structure for Li-air batteries by using appropriate carbons. Generally, high surface area carbon is preferred for constructing air electrodes because a larger surface area means more active sites for electrochemical reactions and also more catalysts can be loaded.

Current Li-air (and Na-air) cells are fabricated in a charged state and, during use, insoluble lithium oxides accumulate in the cathode void space, gradually filling up the battery cathode. This eventually restricts the battery performance by reducing the effective diffusion rates of oxygen from the air side of the cell.

Non-aqueous metal-air batteries using anodes made from alkali and alkaline earth metals other than lithium (e.g. Na, Ca, K etc) also offer great gains in energy density, up to times, over the state-of-the-art Li-ion battery. Metal air batteries are unique power sources because the cathode active material (oxygen) does not have to be stored in the battery but can be accessed from the atmosphere, lowering the weight of such batteries and increasing the charge density. Moreover, alkali and alkaline earth elements are much more abundant than lithium and therefore would offer a more sustainable energy storage solution for even beyond the long-term. Thus, for example sodium cells represent an attractive alternative to lithium cells due to the low cost and ready availability of sodium.

The reaction at the anode:

Na(s)→Na⁺+e⁻

The reactions at the cathode:

Na⁺+O₂+e⁻ [symbol] NaO₂

2Na⁺+O₂+2e⁻ [symbol] Na₂O₂

In the presence of carbon dioxide, additional reactions can occur at the cathode:

2Na⁺+½O₂+CO₂+2e⁻ [symbol] +Na₂CO₃

2Na⁺+2CO₂+2e⁻ [symbol] Na₂C₂O₄

One example of a Na—O₂ battery has been demonstrated using organic carbonate solvents (Sun, Q.; Yang, Y.; Fu, Z. W.; Electrochemistry Communications, 16, 22-25, 2012). The discharge potentials were close to the theoretical and capacities were over 3000 mAh/g (based on a carbon electrode). Decomposition of solvent was identified (by FTIR) during discharge resulting in formation of Na₂CO₃. On charge, the Na₂CO₃ was removed leading to Na⁺ ion and CO₂ formation, indicating reversibility of a sodium carbonate based battery. Prototype K—O₂ batteries have also been prepared (Ren, X.; Wu, Y.; J. Am. Chem. Soc; 135(8) 2923-2926, 2013).

Takechi et al (K. Takechi, T. Shiga, T. Asaoka, Chemical Communications 47 (2011) 3463) have shown that incorporation of CO₂ with the O₂ improves the energy density of a Li—O₂ battery. Unfortunately, the formation of Li₂CO₃ is not reversible. Similar results have been shown for Na—O₂ and Mg—O₂ batteries (S. K. Das; S Xu; L. A. Archer; Electrochemistry Communications, 27, 59-62, 2013). In the case of the Na—O₂ system, the authors observed that Na₂CO₃ and Na₂C₂O₄ were deposited in the carbon cathode pores during discharge.

### BRIEF SUMMARY OF THE DISCLOSURE

Viewed from a first aspect, there is provided a metal-air battery; the battery including a cathode which comprises:
an electronically conductive support material;
a solid metal carbonate; and
a binding agent.

As will be readily understood by the person skilled in the art, in addition to the cathode, a battery comprises an anode and an electrolyte.

The solid metal carbonate acts as an electrochemically active constituent in the cathode of the metal air battery. On charging the solid metal carbonate provides metal ions for the anode. On discharge the metal ions and carbon dioxide (with or without oxygen) form the metal carbonate.

The metal-air batteries of the invention are produced in a discharged state. Upon charging, the metal carbonate will gradually be converted into metal ions, CO₂ (dissolved in the battery electrolyte) and oxygen. Without wishing to be bound by theory, it is expected that this will create additional void space in or around the cathode which, on discharge of the battery, will improve access for oxygen inside the battery, thereby enhancing performance. On further discharging of the battery, the dissolved CO₂ reacts with metal ions (and oxygen) to reform the metal carbonate and refill the void space created during charging.

The solid metal carbonate may be a mixture of more than one metal carbonates. The metal carbonate may be an alkali metal carbonate. The metal carbonate may be a mixture of more than one alkali metal carbonates. Alternatively or additionally, the metal carbonate may be an alkali earth metal carbonate or the metal carbonate may be a mixture of more than one alkali earth metal carbonates. The metal carbonate may be a mixture of more than one alkali metal carbonates and one or more alkali earth metal carbonates. Thus, the metal carbonate may be selected from Li₂CO₃, Na₂CO₃, K₂CO₃, MgCO₃, and CaCO₃ or mixtures thereof. It may be that the metal carbonate is selected from Na₂CO₃, K₂CO₃, MgCO₃, and CaCO₃ or mixtures thereof. In certain preferred embodiments, the metal carbonate is Na₂CO₃. In other preferred embodiments, the metal carbonate is selected from K₂CO₃ and CaCO₃.

Other suitable carbonates include transition metal carbonates, e.g. FeCO₃, MnCO₃, ZnCO₃, which can be used on their own or as a mixture with one or more alkali metal carbonates and/or one or more alkali earth metal carbonates.

It may be that the metal carbonate is not Li₂CO₃.

The metal carbonate may be present in an amount from about 5% to about 65% by weight of the cathode. Thus, the metal carbonate may be present in an amount from about 25% to about 60% by weight of the cathode, e.g. from about 40% to about 50% by weight of the cathode.

The electronically conductive support material may be any material which is electronically conductive and is stable under electrochemical cycling. In an embodiment, the electronically conductive support material is selected from: carbon, a metal carbide, a metal nitride, a metal or semiconductor oxide, a metal boride or similar or a metal or metal alloy matrix. Preferably the electronically conductive support material comprises carbon.

The electronically conductive support material may be present in an amount from about 5% to about 40% by weight of the cathode. Thus, the electronically conductive support material may be present in an amount from about 15% to about 40% by weight of the cathode, e.g. from about 25% to about 30% by weight of the cathode.

It may be that the metal carbonate is bound to the outer surface of the electronically conductive support material. Preferably, however, the metal carbonate particles and the electronically conductive support material particles are distributed substantially homogeneously throughout the cathode. In this case, when the battery is charged and the metal carbonate is converted into metal ions, O₂ and CO₂, the electronically conductive support will take the form of a porous solid with the pores being formed where the metal carbonate once was.

It may be that the cathode pores (when the battery is in the charged state) are completely flooded with the electrolyte. It may be that some of the pores are filled with electrolyte and some are filled with gas (i.e. with O₂ and CO₂).

In an embodiment, the porosity of the cathode (i.e. the proportion of the cathode by volume which is not solid) in the charged state is from about 35% to about 70%. Thus, the porosity of the cathode in the charged state may be from about 45% to about 60%.

Exemplary binding agents include fluorinated polymers (e.g. polyvinylidene fluoride (PVDF), Nafion, polytetrafluoroethylene (PTFE) or a combination thereof).

The binding agent may be present in an amount from about 10% to about 40% by weight. Thus, the binding agent may be present in an amount from about 15% to about 40% by weight of the cathode, e.g. from about 25% to about 30% by weight of the cathode.

The cathode may further comprise a catalyst. If present, a catalyst will typically increase the rate of an electrochemical reaction and may increase the voltage during discharge or reduce the voltage during charge. The catalyst may increase the rate of the oxygen reduction reaction and/or it may increase the rate of the oxygen evolution reaction. The catalyst is typically a metal oxide catalyst (e.g. MnO₂ or Mn₃O₄). The catalyst may be nanoparticulate.

Typically the anode will comprise the same metal as the metal in the metal carbonate. For example, if the metal carbonate is sodium carbonate, the anode will typically comprise sodium. Thus, the anode may comprise an alkali metal. Alternatively or additionally, the anode may comprise an alkali earth metal. Thus, the anode may comprise a metal selected from Li, Na, K, Rb, Cs, Fr, Be, Mg, Ca, Sr, Ba, Fe, Mn, Zn and mixtures thereof, e.g. Na, K, Rb, Cs, Fr, Be, Mg, Ca, Sr, Ba, Fe, Mn, Zn and mixtures thereof. The anode may comprise a metal selected from Li, Na, K, Rb, Cs, Fr, Be, Mg, Ca, Sr, Ba. It may be that the anode comprises a metal selected from: Li, Na, K, Mg, and Ca and mixtures thereof. It may be that the anode comprises a metal selected from: Na, K, Mg, and Ca and mixtures thereof. In a preferred embodiment, the anode comprises sodium. In another preferred embodiment, the anode comprises Ca or K.

The electrolyte will typically take the form of one or more metal salts dissolved in one or more solvents. Exemplary suitable electrolytes are typically based upon organic carbonates, organic ethers, organic sulphates, organic nitriles, organic esters and mixtures thereof. In an embodiment, the or each solvent will be an organic ether. Thus, the or each solvent may be an organic compound containing more than one ether group, e.g. a solvent selected from: 1,2-dimethoxyethane, 1,2-diethoxyethane, 1-tert-butoxy-2-ethoxyethane, diproglyme, diglyme, ethyl diglyme, diethylene glycol dimethyl ether, triglyme, tetraglyme, butyl diglyme and a mixture thereof. The or each solvent may be an organic carbonate, e.g. a solvent selected from: dimethyl carbonate, diethyl carbonate, ethylene carbonate, propylene carbonate and a mixture thereof. In a particular embodiment, the solvent is diethylene glycol dimethyl ether. In another particular embodiment, the solvent is dimethylsulfoxide. In yet another particular embodiment, the solvent is adiponitrile.

In an embodiment, the solvent is saturated with CO₂.

The electrolyte may be a solid electrolyte.

Typically the metal salt or at least one of the metal salts in the electrolyte will comprise the same metal as the metal in the metal carbonate. For example, if the metal carbonate is sodium carbonate, the electrolyte will typically comprise one or more sodium salts. In an embodiment, the salts are selected from: MPF₆, MAsF₆, MN(SO₂CF₃)₂, MClO₄, MBF₄, and MSO₃CF₃ where M is the metal of the metal carbonate (e.g. where M is Li, K Na or Ca). Where the metal of the metal carbonate is divalent (e.g. Mg₂⁺ and Ca₂⁺) the above mentioned salts have the formulae M(PF₆)₂, M(AsF₆)₂, M[N(SO₂CF₃)₂]₂, M(ClO₄)₂, M(BF₄)₂, and M(SO₃CF₃)₂. In a particular embodiment, the electrolyte comprises ClO₄ ions (e.g. the electrolyte is LiClO₄, KClO₄ or NaClO₄). In another particular embodiment, the electrolyte comprises PF₆⁻ ions (e.g. the electrolyte is KPF₆). In yet another particular embodiment, the electrolyte comprises SO₃CF₃ ions (e.g. the electrolyte is Ca(SO₃CF₃)₂

Metal-air batteries need a source of oxygen. This may be an O₂ store which is situated outside the battery. One example of such a store would comprise or be adapted to comprise polyoxymetallates. Another example would be a pressurised gas store which comprises or is adapted to comprise oxygen (e.g. pressurised oxygen or oxygen mixed with nitrogen and/or CO₂). Preferably, the source of oxygen will be a vent which allows ingress of air. In this embodiment, the oxygen consumed by the battery is atmospheric oxygen. This embodiment will generally result in a lighter battery system than alternative oxygen sources and will not need to be replenished or recharged. In an embodiment, the vent comprises a means for removing particulate matter from the air, e.g. a filter. In a further embodiment, the vent comprises a means for removing water from the air, e.g. a hydrophobic membrane. Where the vent comprises both a means for removing particulate matter from the air and a means for removing water from the air, the means for removing particulate matter is preferably external to the means for removing water.

In some embodiments, the anode and the cathode are situated in different compartments. This embodiment is particularly useful for embodiments in which the electrolyte is a solid electrolyte. Thus, the anode compartment and the cathode compartment will typically be separated by an ion porous membrane, e.g. a membrane porous to the metal ions in question (e.g. Na+ ions). An example of a suitable membrane would be sodium beta aluminate.

The electrolyte may be stationary. Alternatively, the battery may comprise a means to induce electrolyte flow around the cathode (e.g. in the cathode compartment). A flowing electrolyte can help improve the distribution of the solid metal carbonate products during discharge and facilitate better distribution of gases.

Viewed from a second aspect, there is provided a method of making a metal-air battery, the method comprising:

forming a composite cathode with an electronically conductive support material and a solid metal carbonate; and

incorporating the cathode into a metal/air battery.

The method of the second aspect may be a method of making a battery of the first aspect. Thus, the battery of the first aspect may be made according to the method of the second aspect.

The step of forming the cathode may comprise coating the electronically conductive support material with the solid metal carbonate. Preferably, it comprises mixing the electronically conductive support material with the solid metal carbonate.

It may be that a binding agent is incorporated into the composite cathode during the step of forming the composite cathode. Thus, a binding agent may be mixed in with the electronically conductive support material and the solid metal carbonate in the mixing step.

In some embodiments, the electronically conductive support material will be in the form of particles or a powder. In these embodiments, the presence of a binding agent is particularly useful.

It may be that a catalyst is incorporated into the composite cathode during the step of forming the composite cathode. Thus, a catalyst may be mixed in with the electronically conductive support material and the solid metal carbonate (and, if present, the binding agent) in the mixing step.

Viewed from a third aspect, there is provided a cathode which comprises:
an electronically conductive support;
a solid metal carbonate; and
a binding agent.

The solid metal carbonate acts as an electrochemically active constituent in the cathode.

Viewed from a fourth aspect, there is provided a method of making a cathode, the method comprising:
mixing an electronically conductive support material with a solid metal carbonate and a binding agent to form a cathode.

In an embodiment of the third or fourth aspects of the invention, the cathode is for use in a metal-air battery. The method of the fourth aspect may be a method of making a cathode of the third aspect. Thus, the cathode of third aspect may be made according to the method of the fourth aspect.

Viewed from a fifth aspect, there is provided a metal-air battery; the battery including a battery cell and a solvent reservoir, wherein the solvent reservoir is in communication with the battery cell and is arranged to trap gases emitted by the battery.

As will be readily understood by the person skilled in the art, a battery comprises an anode, a cathode and an electrolyte. These are typically situated in the battery cell.

CO₂ is present in less than 1% in dry atmospheric air, whereas O₂ is present in around 20%. This means that atmospheric air is not such a good source of CO₂ as it is of O₂. As discussed above, metal-air batteries operating in the presence of carbon dioxide offer technical benefits over those which do not. Practicalities mean that any air-metal battery operating in the presence of carbon dioxide will lose CO₂ in the gas phase on charge, irrespective of the source of the carbon dioxide. This is particularly the case for batteries having as a source of oxygen a vent which allows ingress of air. The solvent reservoir in the batteries of the invention traps this lost CO₂. Some solvent may be lost from the battery with the gases on charge and this can also be trapped in the solvent reservoir. The solvent may act as an additional filter to prevent water entry into the cell.

In an embodiment, the battery further comprises a housing and the solvent reservoir is situated in the housing.

In an embodiment, the solvent of the solvent reservoir is the same as the solvent in the battery electrolyte.

In some embodiments, on discharge, the air stream may be passed through the solvent reservoir before entering the battery. Thus, the solvent reservoir may comprise a porous membrane gas sparger arranged to pass the air stream through the battery. The porous membrane may be hydrophobic.

The air stream passing through the reservoir will carry with it into the battery some of the carbon dioxide dissolved in the reservoir, thus providing a CO₂ enriched air stream. If the solvent in the reservoir and the battery electrolyte are the same, the air stream will also return small amounts of solvent to the battery compartment, countering some or all of the potential solvent loss.

The solvent reservoir may be arranged such that there is a flow of electrolyte between the battery cell and the reservoir. In this configuration, the solvent of the solvent reservoir will necessarily be the same as the solvent in the battery electrolyte. In this configuration, the air stream may be passed only through the solvent reservoir. The flow of the electrolyte takes the air into the battery cell.

The battery of the first aspect may also be a battery of the fifth aspect. In other words, the battery of the first aspect may further include a solvent reservoir as described in the fifth aspect. Thus, the cathode of the first aspect may be situated in the battery cell described in the fifth aspect.

The embodiments of the invention described in this specification may apply to all aspects of the invention, provided they are not mutually exclusive. These embodiments are also independent and interchangeable. Thus, any one embodiment may apply in combination with any one or more other embodiments, provided they are not mutually exclusive. In other words, any of the features described in the aforementioned embodiments may (provided they are not mutually exclusive) be combined with the features described in one or more other embodiments.

### BRIEF DESCRIPTION OF THE DRAWINGS

Embodiments of the invention are further described hereinafter with reference to the accompanying drawings, in which:

FIG. 1 shows the charge-discharge characteristics (between 1.8 and 4.0 V at 0.05 mA cm⁻², charge first, 30° C.) of rechargeable Na-air (fed with dry BOC air) batteries with carbon air cathode consisting of carbon, Na₂CO₃ and PTFE. Electrolyte: 1 M NaClO₄/dithylene glycol dimethylether (pre-saturated with CO₂).

FIG. 2 shows a comparison between the charge-discharge characteristics of rechargeable Na-air and Li-air batteries (fed with dry BOC air). Conditions for the Na-air battery as those in FIG. 1. Conditions for the Li-air battery with carbon only cathode: discharge first between 2.0 and 4.3 V at 0.05 mA cm⁻², 30° C., carbon air cathode consisting of carbon and PTFE. Electrolyte: 1 M LiClO₄/DMSO.

FIG. 3 shows a comparison between the discharge characteristics of rechargeable Na-air and Li-air batteries (fed with dry BOC air). Conditions as those in FIG. 2.

FIG. 4 shows the variation of potential with state of charge for Ca-air battery with a carbon cathode. Electrolyte: 1 M Calcium trifluoromethanesulfonate in tetraethylene glycol dimethylether. Charge/discharge rate: 0.05 mA cm⁻². Temperature: 30° C. The first cycle, which were cycled between 1.0 and 3.0 V in 1 atm of air (BOC cylinder). Capacities are presented as values of per gram of carbon in the electrode.

FIG. 5 shows the variation of potential with state of charge for K-air battery with a carbon cathode. Electrolyte: 1 M potassium hexafluorophosphate in tetraethylene glycol dimethylether. Charge/discharge rate: 0.05 mA cm⁻². Temperature: 30° C. The first cycle, which were cycled between 2.0 and 3.0 V in 1 atm of air (BOC cylinder). Capacities are presented as values of per gram of carbon in the electrode.

### DETAILED DESCRIPTION

The batteries of the invention are described as ‘metal-air batteries’. This term is intended to encompass metal-(O₂/CO₂) batteries. The batteries of the invention could also be described as metal-gas batteries.

### Catalysts

In some embodiments of the invention the cathode comprises a catalyst. If present, a catalyst will typically act to increase the rate of an electrochemical reaction, which may be an oxygen reduction reaction or it may be an oxygen evolution reaction.

Examples of suitable catalysts include: platinum and gold catalysts [see e.g. Lu Y C, H. A. Gasteiger, M. C. Parent, V. Chiloyan, S.-H. Yang, Solid-State Lett., 13 A69 2010]; manganese oxide [see e.g. Cheng H Scott K, J. Power Sources, 195 1370. 2010]; Pd, Ru, RuO₂, PdO and MnO₂ [see e.g. Cheng H, Scott K. Appl. Catalysis B 2011]; iridium oxide; Mn₃O₄; cobalt oxide nanoparticles supported on reduced graphene oxide (Co₃O₄/RGO) mixed with Ketjen black (KB) gave [see e.g. R. Black, J. Lee, B. Adams, C. A. Mims and L. F. Nazar, Angew. Chem., Int. Ed., 2013, 52, 392]; metallic mesoporous pyrochlore oxide, Pb₂Ru₂O (see e.g. S. H. Oh, R. Black, E. Pomerantseva, J. Lee and L. F. Nazar, Nat. Chem., 2012, 4, 1004]; TiN nanoparticles supported on Vulcan XC-72 (LiTFSA in G3) [see e.g. F. Li, R. Ohnishi, Y. Yamada, J. Kubota, K. Domen, A. Yamada and H. Zhou, Chem. Comm., 2013, 49, 1175]; and mixtures thereof.

The catalyst is typically a nanosized metal oxide catalyst (e.g. MnO₂ or Mn₃O₄).

### Solvents and Electrolytes

In selecting a suitable solvent for the batteries of the invention, a number of factors need to be considered.

The oxygen solubility of the solvents commonly employed in sodium and lithium batteries is currently a limitation that results in low current densities. Furthermore, nucleophilic attack by the initially-generated O₂⁻ at the O-alkyl carbon is a common mechanism of decomposition of organic carbonates, sulfonates, aliphatic carboxylic esters, lactones, phosphinates, phosphonates, phosphates, and sulfones. In contrast, nucleophilic reactions of O₂⁻ with phenol esters of carboxylic acids and O-alkyl fluorinated aliphatic lactones proceed via attack at the carbonyl carbon. Chemical functionalities stable against nucleophilic substitution by superoxide include some N-alkyl substituted amides, lactams, nitriles, and ethers. The solvent reactivity is strongly related to the basicity of the organic anion displaced in the reaction with superoxide [Bryantsev V S, et al. Phys. Chem. A, 115 (44), 12399, (2011)].

The solubility of carbon dioxide will also be a factor.

Solvents which might be considered include: 1,2-dimethoxyethane, 1,2-diethoxyethane, diethyl carbonate, 1-tert-butoxy-2-ethoxyethane, diproglyme, diglyme, ethyl diglyme, propylene carbonate, triglyme, tetraglyme and butyl diglyme. Of these, triglyme and tetraglyme have very low evaporation rates (with negligible vapour pressures of 0.2 and <0.01 mmHg at 25° C.) and good stability and might be used in any application in which solvent evaporation is found to be a problem. If stability is not as might be desired, the use of co-solvents can lead to stable systems. In addition, the mixed solvent based electrolytes may present synergistic effects, such as addition of ethylene carbonate (EC) to dimethyl carbonate (DMC) where the electrochemical stability is high up to 5 V (vs. Li/Li⁺), otherwise pure DMC is liable to be oxidized at ˜4.0 V (vs. Li/Li⁺).

Exemplary suitable electrolytes can be formed from any liquid organic capable of solvating metal salts (e.g. for alkali metals: MPF₆, MAsF₆, MN(SO₂CF₃)₂, MClO₄, MBF₄, and MSO₃CF₃ where M is the metal of the metal carbonate), but have typically been based upon carbonates (e.g. ethylene carbonate and/or diethyl carbonate), ethers, and esters. In a particular embodiment, the solvent is diethylene glycol dimethyl ether. In another particular embodiment, the solvent is dimethylsulfoxide. In a particular embodiment, the electrolyte comprises ClO₄⁻ ions.

Some polymer electrolytes form complexes with alkali metal salts, which produce ionic conductors that serve as solid electrolytes.

### Binding Agents

Suitable binding agents will be well known to those skilled in the art. Examples of suitable binding agents for use in the invention include: styrene butadiene copolymer; cellulose (e.g. carboxymethyl cellulose); polymers consisting of carboxymethyl cellulose with ethylene-vinyl alcohol, N-methyl-2-pyrrolidone copolymer, polyacrylonitrile or ethyl lactate and combinations thereof; polymers consisting of butadiene (e.g. 1,3-butadiene) and ethylenically aliphatic hydrocarbon monomers; polymers consisting of polyvinylidene fluoride and N-methylpyrrolidone; polymers consisting of carboxylic acid groups containing fluorene/fluorenone copolymers; polymers consisting of acrylic acids (such as 3-butenoic acid, 2-methacrylic acid, 2-pentenoic acid, 2,3-dimethylacrylic acid, 3,3-dimethylacrylic acid, trans-butenedioic acid, cis-butenedioic acid and itaconic acid etc.); polymers consisting of styrene, 1,3-butadiene, divinylbenzene sodium dodecylbenzenesulfonate and azobisisobutyronitrile; polyvinylidene fluoride (PVDF), Nafion, polyacrylonitrile; and polytetrafluoroethylene (PTFE).

### Anodes

Suitable anodes include those formed from the metal itself (including liquid sodium in the case of a sodium-air battery) as well as: intercalation materials (e.g. graphite intercalation materials), such as those containing silicon based alloy additives, titanate additives; silicon carbon nanocomposites; and polymer based materials. The anode may also be a particulate material, although typically it will be in the form of a solid sheet.

### Separator Materials

Suitable materials for separating the anode and cathode compartments include: glass fibres filled with electrolyte, other porous separator materials; solid metal ion conductors based on ceramics and glass, polymers with metal ion conduction; nonwoven fibres (cotton, nylon, polyesters, glass), polymer films (polyethylene, polypropylene, poly(tetrafluoroethylene), polyvinyl chloride, and naturally occurring substances (rubber, asbestos, wood). Both dry and wet processes can be used for fabrication; non-woven fibres consist of a manufactured sheet, web or matt of directionally or randomly oriented fibres; supported liquid membranes consist of a solid and liquid phases contained within a microporous separator. Separators can use a single or multiple layers/sheets of material.

Solid ion conductors can serve as both separator and the electrolyte.

### Solvent Reservoir

The solvent reservoir may be a separate chamber built into the battery next to the cathode chamber. Between the cathode and the solvent reservoir there would be a gas permeable membrane which would allow the transfer of gas from for example the air. At the air side of the solvent reservoir would be an air filter and moisture separation layer.

Alternatively the reservoir would be a separate unit with a filtered air/O₂/CO₂ inlet which also prevents water entering. The air/CO₂ would bubble through the reservoir and the gas stream would then enter the battery.

A type of vapour transfer device similar to a membrane water humidifier, used for example in fuel cell gas humidification, could be used. Here the gas stream flows on one side of a liquid permeable membrane and the liquid transfers through the membrane to the gas stream.

### Construction

In a non-aqueous air/metal battery according to the invention battery the cathode has to accommodate accumulation of the solid insoluble carbonaceous and oxide products (and transformation to metal ions and CO₂/O₂ on charging). Thus there is a compromise to be made between porosity and active area for catalysis and electron transfer.

In one exemplary battery of the invention, the cathode was made from a mixture of carbon (3 mg/cm²), solid sodium carbonate (5 mg/cm²) and PTFE (3 mg/cm²) as binder. This mixture was dispersed in the organic solvent electrolyte (diethylene glycol dimethylether) and pasted onto an Al current collecting grid. On complete charge the battery has a larger porosity which facilitates easy access of the reacting gases (CO₂ and O₂) into the cathode and easy formation of sodium carbonate with less blocking of the pores, thus improving cell performance.

One method which has been used to make a battery of the invention is as follows:

The air cathode for the Na battery was fabricated using a weight ratio of C:Na₂CO₃:binder (PTFE):solvent (diethylene glycol dimethylether) is 10:15:10:40. The desired amounts of materials were mixed in an ultrasonic bath for 1 h. The mixture was printed onto a glass microfibre separator (Whatman) which was pre-treated using an electrolyte of 1 M NaClO₄ in diethylene glycol dimethylether. A gas diffusion layer, consisting of carbon powder (0.5 mg cm⁻²) in diethylene glycol dimethylether, was prepared using the above-mentioned procedure and then printed onto the above mixture layer. Every layer was dried at 80° C. under Ar atmosphere before spreading a new layer. Finally, a thin layer of mixture of ether and acetone was spread onto the electrode surface. All electrodes were dried overnight at 105° C. under Ar atmosphere. A real composition of a typical cathodes was (2 mg carbon, 3 mg Na₂CO₃ and 2 mg PTFE) cm⁻².

Another feature of this battery is that CO₂ has a high solubility in the battery solvent and a majority of the CO₂ emitted on charging dissolves in the solvent.

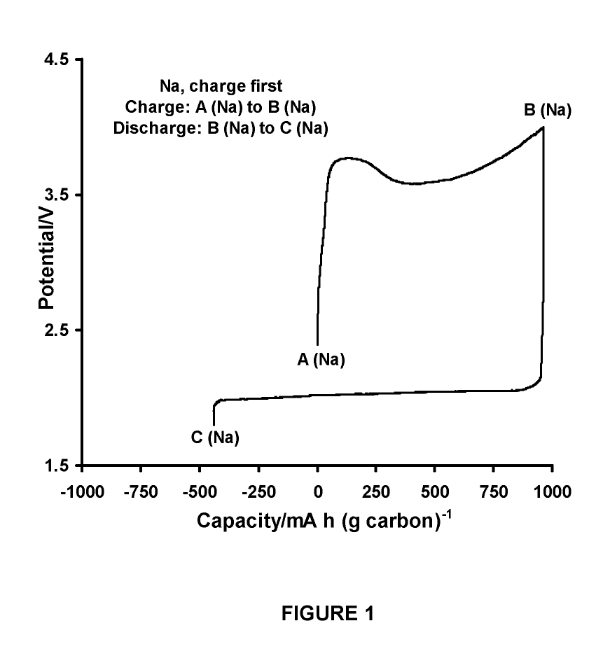

FIG. 1 shows the cycling performance of the sodium carbonate battery in terms of the change in capacity (mAmp hours) and the voltage during charging and discharging. The battery included a sodium metal anode and the cathode described above in sodium perchlorate/dithylene glycol dimethylether (pre-saturated with CO₂). Starting from a charged state (A) voltage rises very quickly to the cell charging potential, after which the sodium carbonate is converted to sodium ions and CO₂. At point B charging is stopped and the battery is run in the discharging mode (power generation) at a voltage of approximately 2.1 V. The capacity on discharge is approximately 1450 mAh/g and is some 450 mAh/g greater than that during charge. This is achieved because of the additional pore volume the battery creates for solid deposits (carbonates) by starting with sodium carbonate in the cathode.

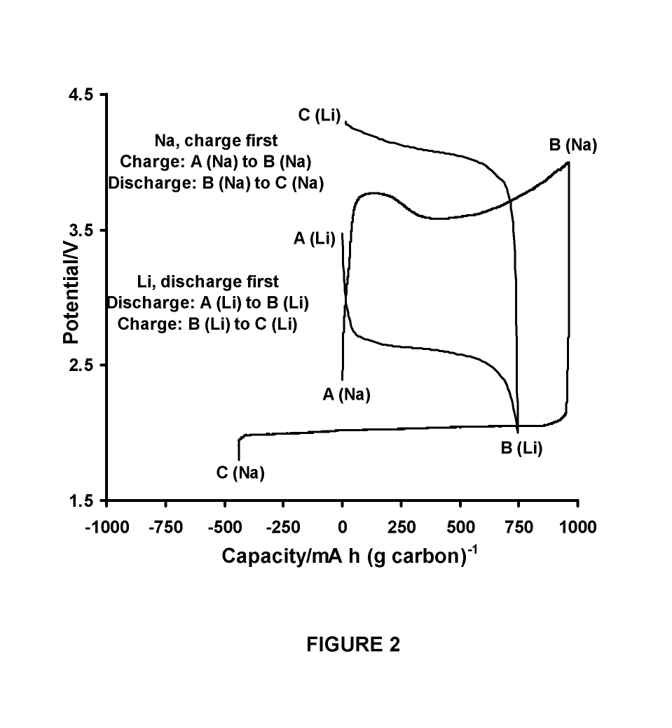

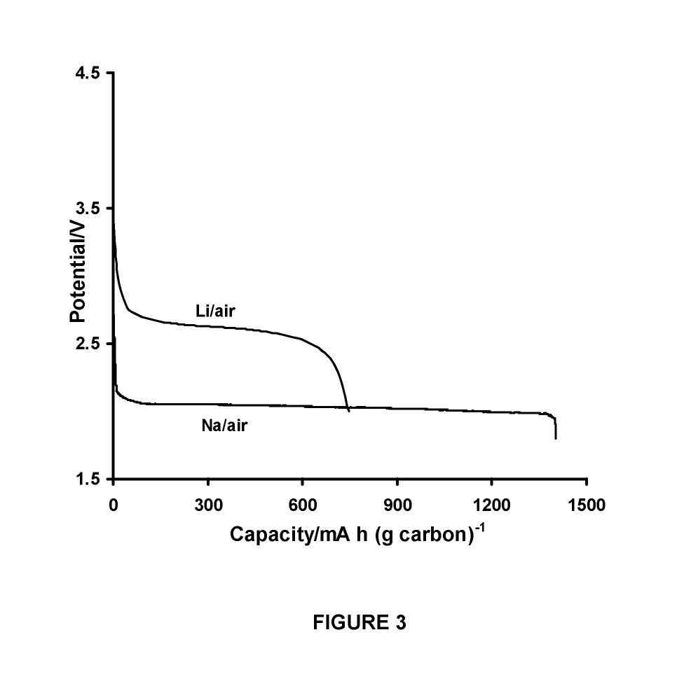

FIG. 2 and FIG. 3, show for comparison, data from a Li/air battery with a carbon only cathode. In terms of the capacity the Na-battery has twice the capacity of the Li-air battery.

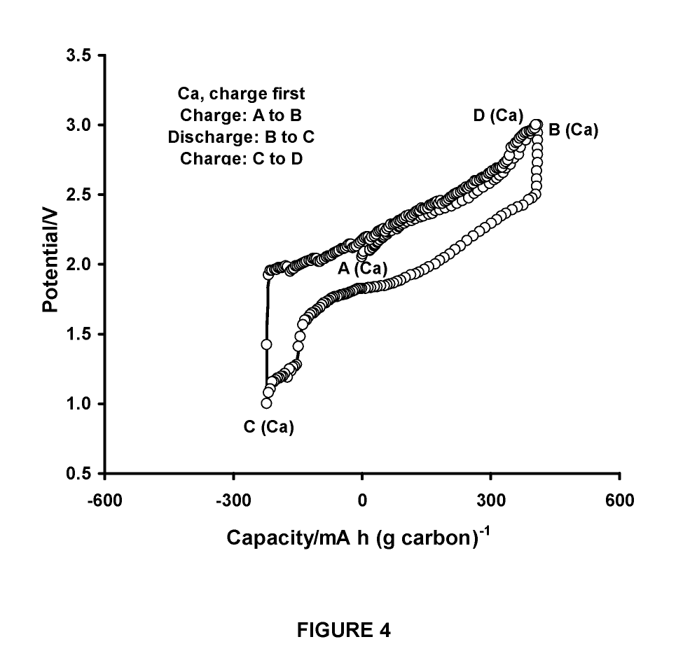

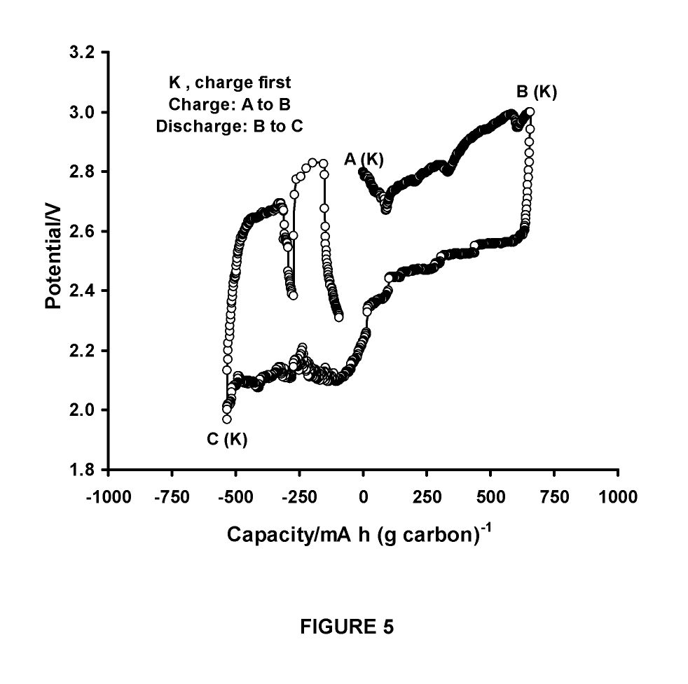

FIGS. 4 and 5 show the cycling performance of calcium and potassium carbonate batteries respectively in terms of the change in capacity (mAmp hours) and the voltage during charging and discharging.

Of the batteries tested, the Na-air battery has the largest discharge capacity.

However, the K-air and Ca-air batteries show higher round-trip efficiency than the Na-air battery, which is a ratio of total energy storage system output (discharge) divided by total energy input (charge) as measured by ratio of discharge voltage divided by charge voltage.

The results are even comparable with those achieved using pure O₂, not air (as reported in Das et al mentioned in the Background section above). Although the discharge potential is some 300 mV lower for the Na battery compared with the Li battery; the charge potential is lower and is advantageous in terms of reducing the effect of battery solvent degradation. Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments.

The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXPERIMENTAL

Electrodes:

Sodium cubes (99.9%), potassium cubes (99.5%) and calcium pieces (99%, Sigma-Aldrich) were used as anodes. The air cathode for the batteries were fabricated using a mixture of carbon black powder (Norit), Na₂CO₃, CaCO₃ or K₂CO₃ (ACS reagent, Sigma-Aldrich), PTFE powder (1 μm particle size, Sigma-Aldrich) and DMSO.

Batteries and Cycle Performance Test:

The air cathodes were used to assemble Swagelok type rechargeable batteries with a Na, K or Ca anode, a glass microfibre filter (Whatman) separator, soaked in 1 M sodium chlorate, potassium hexafluorophosphate or calcium trifluoromethanesulfonate in DMSO. The batteries were first discharged and then charged between 1.8 and 4.0 V, 2.0 and 3.0 V, 1.0 and 3.0 V or 2.0 and 4.3 V for the Na-air, K-air, Ca-air or Li-air batteries, versus Na/Na⁺, K/K⁺, Ca/Ca²⁺ and Li/Li⁺, respectively. Battery tests were performed with a Maccor-4200 battery tester (Maccor).

1. A metal-air battery; the battery including a cathode which comprises:
an electronically conductive support material;
a solid metal carbonate; and
a binding agent.

2. A battery according to claim 1, wherein the binding agent is present in an amount from about 10% to about 40% by weight of the cathode.

3. A battery according to claim 1, wherein the metal carbonate is selected from Li₂CO₃, Na₂CO₃, K₂CO₃, MgCO₃, and CaCO₃.

4. A battery according to claim 1, wherein the metal carbonate is Na₂CO₃.

5. A battery according to claim 1, wherein the electronically conductive support material is selected from: carbon, a metal carbide, a metal nitride, a metal or semiconductor oxide, a metal boride or a metal or metal alloy matrix.

6. A battery according to claim 1, wherein the electronically conductive support material is carbon.

7. A battery according to claim 1, wherein the binding agent is a fluorinated polymer.

8. A battery according to claim 1, wherein the binding agent is selected from polyvinylidene fluoride (PVDF), Nafion, polytetrafluoroethylene (PTFE) and a combination thereof.

9. A battery according to claim 1, wherein the metal carbonate is present in an amount from about 25% to about 60% by weight of the cathode.

10. A battery according to claim 1, wherein the electronically conductive support material is present in an amount from about 15% to about 40% by weight of the cathode.

11. A method of making a metal-air battery, the method comprising:
forming a composite cathode with an electronically conductive support material and a solid metal carbonate; and
incorporating the cathode into a metal/air battery.

12. A method according to claim 11, wherein the cathode comprises (i) the electronically conductive support material, (ii) the solid metal carbonate, and (iii) a binding agent.

13. A cathode for a metal-air battery, the cathode comprising:
an electronically conductive support material;
a solid metal carbonate; and
a binding agent.

14. (canceled)

15. A metal-air battery, the battery including a battery cell and a solvent reservoir, wherein the solvent reservoir is in communication with the battery cell and is arranged to trap gases emitted by the battery.

16. A metal-air battery according to claim 15, wherein there is a flow of electrolyte between the battery cell and the reservoir.

17. A metal-air battery according to claim 15, wherein on discharge, an air stream is passed through the solvent reservoir before entering the battery.

18. A metal air battery according to claim 15, wherein the battery cell comprises a cathode comprising (i) an electronically conductive support material, (ii) a solid metal carbonate, and (iii) a binding agent.
